(19) United States
(12) Patent Application Publication
(10) Pub. No.: US 2003/0176179 A1
(43) Pub. Date: Sep. 18, 2003

(54) Wireless local area network and antenna used therein

(76) Inventors: Ken Hersey, Clarksville, MD (US); Shuguang Chen, Ellicott City, MD (US); Cornelis Du Toit, Ellicott City, MD (US); John Kvarnstrand, Columbia, MD (US); Jay Patel, Columbia, MD (US); Donya He, Montgomery Vilage, MD (US); Peter Acsadi, Parkton, MD (US); Chenggang Sui, Ellicott City, MD (US)

Correspondence Address: James S. Finn, Paratek Oakland Mills Road, 6935 G Oakland Mills Road, Columbia, MD, 21045, US

(21) Appl. No.: 10/388,788

(22) Filed: Mar. 14, 2003

Related U.S. Application Data
(60) Provisional application No. 60/365,383, filed on Mar. 18, 2002.

(51) Int. Cl. H04B 1/16

(52) U.S. Cl. 455/334; 455/130

(57) ABSTRACT

A wireless local area network that utilizes a dynamically reconfigurable wireless network antenna that comprises at least one multi-layered RF module, said at least one RF module further comprising at least one RF connector for receipt of at least one RF signal and at least one layer of tunable dielectric material and one layer of metal fabricated into said RF module; an RF motherboard for acceptance of RF signals and distribution of the transmit energy to said RF module at the appropriate phases to generate a beam in the commanded direction and width; and a controller for determining the correct voltage signal to send to said at least one multi-layered RF module.

### CROSS-REFERENCE TO RELATED APPLICATION

This application claims the benefit of priority under 35 U.S.C Section 119 from U.S. Provisional Application Ser. No. 60/365,383, filed Mar. 18, 2002, the disclosure of which is hereby incorporated by reference in its entirety for all purposes.

### BACKGROUND OF THE INVENTION

This invention relates to wireless local area networks (WLANs) and, more specifically, WLANs using a novel dynamically reconfigurable wireless network antenna. The antenna subject of this invention can also be used in other applications, such as RFID tag reader, smart card reader, etc.

The ability of computer users to access programs and share data through local area networks (LANs) has become a readily expected part of most working environments. The improved efficiency within a particular LAN environment is often enhanced with the convenience of remotely accessing the LAN. An important extension to LANs is the provision of a wireless LAN (WLAN).

In a WLAN, end station units suitably employ radio communication using an FCC allotted frequency band of, for example, 2422 MHz (megaHertz) to fulfill performance expectations of wired LANs but without costly wire installation. One example of a WLAN can have three end station units that and are in range with one another and form a portion of a WLAN. Also typically included in a WLAN is an access point station that can access both connection oriented and connection-less services. This access point station thus may support connection to both a local Ethernet backbone and some form of telecommunication transport, such as ISDN, ATM, or T1, as is well appreciated by those skilled in the art.

Regarding the importance of WLANs, most analysts agree that the WLAN market segment is set to take off in 2001, reaching $1.6 to $2.2 billion by 2005. Gartner Group, an analyst firm specializing in the computer industry, characterized it best when it stated that, “Investments at the desktop are idle, because people are spending less time at their desks.” Wireless voice is common, while wireless data is not. Yet, more than 90 percent of all communications traffic consists of data and not voice—this represents a huge reservoir of potential growth. Laptops now make up about 25 percent of corporate purchases (Intel Corporate Market Research, 2000), while 75 percent of large organizations are evaluating WLANs (Campbell DeLong Resources, Inc., 1/2000).

Wireless connectivity is moving from the back office to the front office and from workers who must communicate while traversing warehouses, to marketing personnel who need to take their productivity tools down the hall or across the campus. Thus it is seen that wireless networking is a natural extension to a company's wired network. Regarding the performance of WLANs, it has been demonstrated that high-performance, wireless solutions greatly increase productivity with real-time access to e-Business applications and valuable networked data. In a non-commercial environment, wireless networking allows teachers to more easily integrate the educational environment by allowing networking resources, including the Internet, to change the way students learn, affording them more control and interaction in their learning experience.

Further, Wireless LANs can help a small business inexpensively network its PCs and peripherals. There is no money or time spent on installing space-consuming network cable. For example, an orthodontist can use his laptop between patient rooms and use a virtual imaging application to project what a patient's teeth will look like after braces. This can be done over a wireless network, eliminating the need for a PC and network connection in each patient room. And at the touch of a button, the dentist can send a copy of the image to the front desk printer for the patient to grab on the way out the door.

At colleges and universities, it is increasingly common for students to carry and use laptop computers. Institutions are responding with wireless Access Points located in libraries, student lounges and even dormitories. The result: students can have 24-hour access to the Internet and the institution's network, without the need to be connected to wires.

Large organizations can enable wireless mobility throughout a campus, or connect LANs together for a fraction of the cost of traditional Wide Area Network (WAN) technologies. Wireless LANs also make it much easier to add or move workstations, and to provide connectivity in areas where it is difficult to lay cable. An additional benefit is the entire wireless network can be managed from one location, anywhere in the world and it has enhanced security/access control to thwart hackers or intruders. So as it can be seen, there are as many potential applications as there are organizational categories.

For all of the aforementioned virtues, there are however, serious problems with the current state of the art. While wireless networks can be deployed relatively easily compared with wired networks, they nevertheless face several challenges and limitations. The relatively severe rain attenuation at frequencies above 20 GHz limits the distances between nodes for a given system availability. The quality of the radio link between nodes depends on the transmitted power, the link distance, the interference environment, and the gains of the transmitting and receiving antennas.

There is a tradeoff between the antenna gain and the area coverage of a link. Typically, area coverage is accomplished with several antennas. As the antenna sector coverage is reduced, the antenna gain and the link are improved at the expense of coverage area. Therefore, more antennas are needed to cover the area. For example, a hub site may incorporate four antenna beams, each covering a 90-degree azimuth sector and each having a relatively narrow elevation beam or, alternatively, eight sector beams of 45° each. The link transmission could be improved by further narrowing the sector beams (thereby increasing their gain) at the added expense of requiring more antennas to fill in the coverage. Generally, a compromise is reached where a relatively small number of antennas (e.g. four) are employed either at a hub site or a mesh node and each antenna accommodates several users. For a given set of limitations on transmitter power, the number of nodes required to cover an area, such as a city, is higher than it would be if the radio link used antennas with high gain. Yet, the higher gain requires more antennas at each node, thereby increasing the equipment cost and complexity.

Many of these shortcomings can be attributed to the omni-directional aspect of current antennas, and the materials used therein, used in wireless LANs. Thus, there is a strong need in the WLAN industry for a wireless local area network that can take advantage of directionality in its transmissions and a material and structure that enables it. WLAN antenna subject of this invention can be used in the Access Point, at the client site, or both.

### SUMMARY OF THE INVENTION

The present invention includes a wireless local area network that utilizes a dynamically reconfigurable wireless network antenna that comprises at least one multi-layered RF module, said at least one RF module further comprising at least one RF connector for receipt of at least one RF signal and at least one layer of tunable dielectric material and one layer of metal fabricated into said RF module; an RF motherboard for acceptance of RF signals and distribution of the transmit energy to said RF module at the appropriate phases to generate a beam in the commanded direction and width; and a controller for determining the correct voltage signal to send to said at least one multi-layered RF module.

The invention also encompasses a wireless method of data transmission from an access point in a local area network, comprising the steps of providing a transceiver within said access point, said transceiver further including an antenna, said antenna comprising at least one multi-layered RF module, said at least one RF module further comprising at least one RF connector for receipt of at least one RF signal and at least one layer of tunable dielectric material and one layer of metal fabricated into said RF module; an RF motherboard for acceptance of RF signals and distribution of the transmit energy to said RF module at the appropriate phases to generate a beam in the commanded direction and width; a controller for determining the correct voltage signal to send to said at least one multi-layered RF module; and transmitting information via said antennas using directional beams.

Further, this invention discloses and claims a wireless local area network access point wherein said access point comprises a transceiver; an antenna associated with said transceiver, said antenna comprising: at least one multi-layered RF module, said at least one RF module further comprising at least one RF connector for receipt of at least one RF signal and at least one layer of tunable dielectric material and one layer of metal; an RF motherboard for acceptance of RF signals and distribution of the transmit energy to said RF module at the appropriate phases to generate a beam in the commanded direction and width; and a controller for determining the correct voltage signal to send to said at least one multi-layered RF module.

### BRIEF DESCRIPTION OF THE DRAWINGS

FIG. 1 is an illustration of an example WLAN environment with a single carrier version of the present invention;

FIG. 2 is an illustration of an example WLAN environment with the multi-beam embodiment of the present invention;

FIG. 3 is an illustration of an example WLAN environment with the multiple beams, frequency reuse embodiment of the present invention;

FIG. 4 depicts the WLAN antenna of the present invention;

FIG. 5 is an exploded view of the WLAN antenna of the present invention;

FIG. 6 is a more detailed exploded view of the RF Boards construction of the WLAN antenna of the present invention;

FIG. 7 is a more detailed exploded view of the base construction of the WLAN antenna of the present invention;

FIG. 8 is a more detailed exploded view of the RF Module construction of the WLAN antenna of the present invention;

FIG. 9 is a depiction of a detailed view of the various inputs into the base of the WLAN antenna of the present invention.

### DESCRIPTION OF THE PREFERRED EMBODIMENT

The present invention serves as an internal or external antenna for a WLAN application and can be utilized at the access point or at the end user's device or both. The antenna interfaces to a computer at the WLAN transceiver card and the parallel port if used in an external embodiment. The transceiver card may be a PCMCIA card in a laptop, or a PCI card in a desktop computer. The antenna can also interface with a Smartcard reader an RFID reader or any other device which can utilize the properties of the present invention for significant performance advantages. The card and the antenna can operate in the 2.4 GHz Industrial, Scientific and Medical (ISM) band, or the 5.1-5.8 GHz band, although it is understood that they can operate in other bands as well. A software driver functions to control the antenna azimuth scan angle to maximize the received wireless signal, and hence the data rate performance of the wireless link. In this embodiment, the key performance requirement to steer a beam with 6 dBi of gain throughout a 3600 azimuth scan is enabled.

Existing WLANs currently use fixed antennas. Most often, omnidirectional antennas are used, which are typically integrated into the WLAN card or exist as an integral monopole antenna. External high gain antennas exist; however, these have a fixed beam that the user must manipulate by hand. The present invention requires no user intervention and ensures maximum performance in a plug-and-play environment.

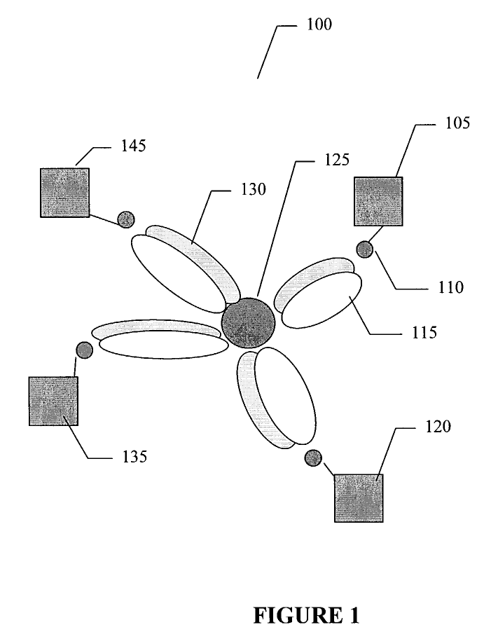

The present invention can be implemented in several networking embodiments. FIG. 1 depicts a single carrier version wherein network 100 has access point 125 and receiving devices 105, 120, 135 and 145 (such as any informational device such as a PDA, computer, or any other device used for receiving information from access point 125). In this single carrier solution, multiple channels are possible using the tunable technology of the present invention. In this example, the multiple channels 115 and 130 allow for at least 11 Mbps bandwidth using only 22 MHz of spectrum.

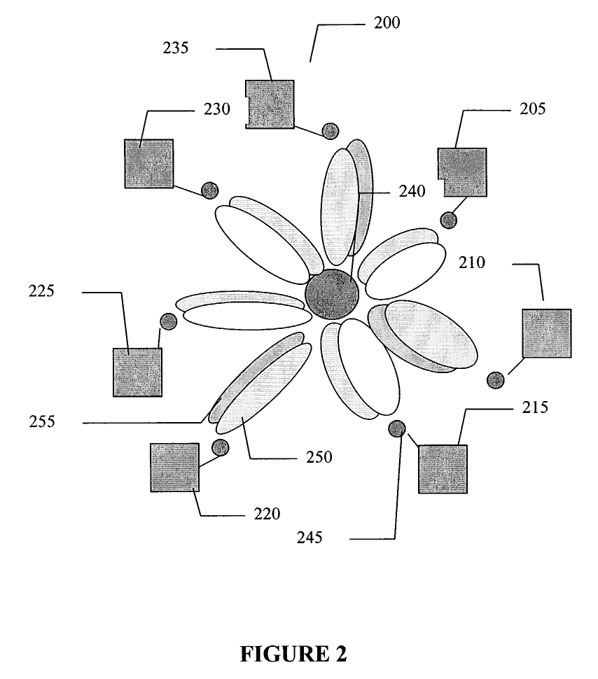

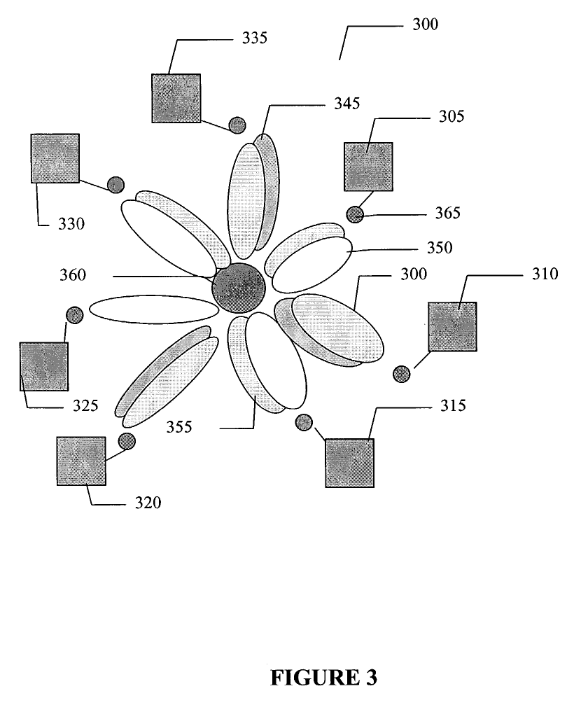

FIG. 2 depicts the multi-beam embodiment wherein network 200 has access point 240 and receiving devices 205-235. In this multi-carrier solution multiple beams 250 and 255 are used with one beam for each channel. In this embodiment, at least 22 Mbps is achieved with 44 MHz of spectrum. FIG. 3 depicts the multiple beams, frequency reuse embodiment of the present invention. Herein network 300 has access point 360 and receiving devices 305-335. In this multiple-beam, frequency reuse embodiment individual channels 350 and 355 for all beams are used. A reception antenna for a receiving device is illustrated at 365. It is understood that all receiving devices will have a reception antenna. In this embodiment at least 22 Mbps using 22 Mhz is achieved.

As will be shown in the figures to follow, the preferred embodiment of the present invention may contain the following subassemblies in antenna 400, with exploded view shown as 500: RF Modules 515, RF Motherboard 545, controller connector 915 (with connector screws 910 and 920), base 410, radome 405, external RF cables [MMCX to transceiver card] (not shown), external control cables (not shown), external power supply connector 905 and a software driver. The external RF and control cables connect the antenna 400 to the user's computer. The power supply cable connects between an AC outlet and the antenna 400. Mating MMCX jacks 415 and 420, DB-25 female, and DC power jack connectors 905 are located on the side of the product's base. The DC power jack 905 and DB-25 connector 915 are right angle connectors integral to the controller Printed Circuit Board (PCB), with the mating portions 415, 420 exposed through the base 410. Once inside the housing, the RF signals are transferred to the RF motherboard 545 via flexible coaxial cables (not shown) to a surface mount interface 535.

The controller determines the correct voltage signals to send to the motherboard 545, as requested by the received software command and the current internal temperature sensed at the phase shift modules. These voltages are sent across a ribbon cable (not shown) to the switches and phase shifters located on the motherboard 545. The controller also provides feedback to the computer so that the software can determine if the antenna is present or not. The controller mounts rigidly to the inside bottom of the base 410 with its main connector 915 exposed.

The motherboard distributes the RF signals to the nine RF modules 515 via RF connectors 510 and 520. The dual RF input allows for horizontal or vertical polarization. The signal from the main connectors 595 and 535 are divided three ways, each to a phase shifter and then an SP3T switch. The outputs of the switch terminate in nine places, one for each RF module. This permits any of three consecutive RF modules 515 to be active and properly phased at any time. The motherboard (not shown) mounts rigidly to the top side of the base 410, which is stiffened to ensure that the phase shift and power divider modules will not shatter under expected environmental conditions. Cutouts 575 exist in the top of the base for connector pins and cable access features.

The RF modules consist of a multilayer antenna for broad bandwidth. They are connected to the motherboard via a flex microstrip circuit. The modules are mounted perpendicular to the motherboard, and are secured to the base via vertical triangular posts 525.

The radome 405 fits over the product and is fused to the base 410, both at the bottom of the radome 405 and top of the base 410 intersection, and at the base posts to the inside top of the radome 405.

Subassembly Descriptions

RF Modules 515

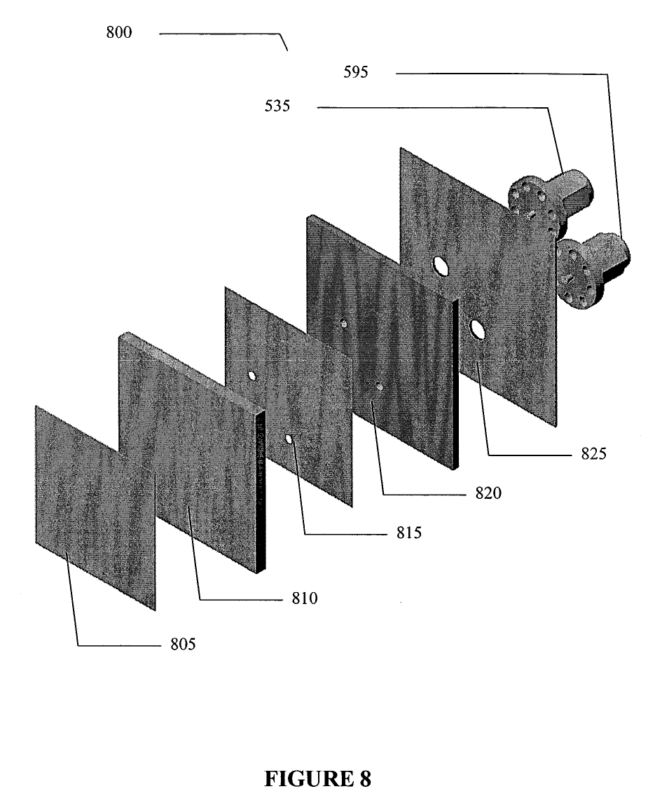

In the preferred embodiment of the present invention, nine RF modules 515 are required for the assembly of each antenna. As shown in FIG. 8, 800, each module is a multilayer bonded structure consisting of alternating metal 805, 815, 825 and dielectric 810, 820 layers. Although, nine RF modules 515 are depicted in this preferred embodiment, it is understood that one skilled in the art can vary the number of RF modules according to performance parameters and design choice.

The outer layer 825 of the subassembly 515 can be a stamped brass element about 1.4″±0.002″ square. This brass element is bonded to a block of dielectric 1.5″±0.01″ square 820. A target material can be polystyrene if cost is a consideration, where the requirements are a dielectric constant between 2.6 and 3.0. Once established in the design, the dielectric constant should be maintained at frequency within 2%. The loss tangent of this dielectric should not exceed 0.002 at 2.5 GHz. The above assembly is bonded to an inner metal layer of stamped copper element 815 plated with immersion nickel-gold and is about 1.4″±0.002″ square. The above assembly is then bonded to another block of identical dielectric 1.7″×1.8″±0.01″ square 805. This subassembly is completed with a bonded flex circuit described below in the interconnection section.

RF Motherboard 545

The RF motherboard 545 consists of a 9-sided shaped microwave 4-layer PCB. Although it is understood that the shape of the motherboard and the number of sides can be modified to alternate shapes and sides without falling outside the scope of the present invention. In the present invention, the inscribed circular dimension is 4.800±0.005″. Rogers RO4003 material with ½ ounce copper plating is used for each of the three 0.020″ dielectric layers. This stack up permits a microstrip top layer and an internal stripline layer. All copper traces can be protected with immersion nickel-gold plating. Alternate substrate materials can be considered for cost reduction, but should have a dielectric constant between 2.2 and 3.5, and a loss tangent not exceeding 0.003 at 2.5 GHz.

The motherboard functions to accept two signals from the MMCX connectors 415, 420 from individual coaxial cables and properly distribute the transmit energy to the appropriate elements at the appropriate phases to generate a beam in the commanded direction. The coaxial cables have a snap-on surface mount connection to the motherboard. Each of these cables feed a 3-way power divider module, described below. The output of each power divider connects to a 90°-phase shifter module, also described below. The output of each phase shifter feeds a SP3T switch. In the preferred embodiment, a Hittite HMC241QS16 SP4T MMIC switch was selected, although a multitude of other switches can be utilized. Three of the switched outputs connect go to the module connection landings, in alternating threes; that is, switch #1 connects to modules 1, 4, and 7, etc. It is the alternating nature that requires the motherboard to be multilayer, to permit crossover connections in the stripline layer. Thus, one skilled in the art can utilize design choice regarding the number of layers and switch to module connections. At the output of each switched line is a 10 V DC blocking capacitor; and, at each end of the phase shifter is a 100 V DC blocking capacitor. These fixed capacitors should have a minimum Q of 200 at frequency, and are nominally 100 pF.

Three-Way Divider

The three-way divider can be a 1″×1″×0.020″ 96% Alumina SMD part. Copper traces are on the top side and a mostly solid copper ground plane is on the bottom side, except for a few relief features at the port interfaces. All copper is protected with immersion nickel-gold plating. There are no internal vias on this preferred embodiment of the present invention. Provisions can be made to enable the SMD nature of this inherently microstrip four-port device.

90° Phase Shifter

The 90° phase shifter is a 1″×1″×0.020″ 96% Alumina SMD part. Copper traces are on the top side and a mostly solid copper ground plane is on the bottom side, except for a few relief features at the port interfaces. All copper is protected with immersion nickel-gold plating. There are two internal vias to ground on the device. Two thin film SMD Parascan varactors are SMT mounted to the top side of this device. Some provisions can be made to enable the SMD nature of this inherently microstrip two-port device. Parascan is a trademarked tunable dielectric material developed by Paratek Microwave, Inc., the assignee of the present invention. Tunable dielectric materials are the materials whose permittivity (more commonly called dielectric constant) can be varied by varying the strength of an electric field to which the materials are subjected or immersed. Examples of such materials can be found in U.S. Pat. Nos. 5,312,790, 5,427,988, 5,486,491, 5,693,429 and 6,514,895. These materials show low dielectric loss and high tunability. Tunability is defined as the fractional change in the dielectric constant with applied voltage. The patents above are incorporated into the present application by reference in their entirety.

Controller

The controller consists of a 3″×5″×0.031″ 4-layer FR-4 PCB. It has SMD parts on the top side only, as is mounted to the bottom of the base 410. The controller has two right angle PCB-mount external connectors 415, 420 that can be accessed through the base 410. A DB-25 female connector 915 is used for the command and a DC power jack 905 is used to receive the DC power. It is, of course, understood that any connector can be used for command and power connection.

The controller contains a microprocessor and memory to receive commands and act on them. Based upon the command, the controller sends the proper TTL signals to the SP3T switches and the proper 10 to 50 V (6-bit resolution) signals to the phase shifters. To send these high voltage signals, a high voltage supply, regulator, and high voltage semiconductor signal distribution methods are used.

Base 410

The design choice for this preferred embodiment has a base formed from black Acrylonitrile Butadiene Styrene (ABS) and measures 6.5″ round in diameter and 0.5″ in main height. The bottom is solid to accommodate the controller board, and the side has one flat surface for the connectors. The top side at the 0.5″ height is reinforced in thickness to achieve the rigidity to protect the Alumina modules; or, a thin 0.1″ aluminum sheet could be used in addition at the top if needed.

Extending from the main top side level are nine vertical triangular posts 525 that make the overall height 3.0 inches, minus the thickness of the radome 405. This ensures that the radome 405 inside surface contacts the base posts. These posts 525 provide alignment and centering for the RF modules that connect to the RF motherboard via flex circuit sections. The RF modules are bonded in place to these posts. At the lower portion of base 410 are openings 555 and 590, whereat RF connectors 420 and 415 protrude.

Internal Interconnect and Distribution

The RF MMCX bulkhead jacks 415, 420 are connected to the RF motherboard 545 via thin coaxial cables. These cables are integral to the bulkhead connector 595 and 535 and have surface mount compatible snap-on features to attach to the motherboard. The controller sends its voltage signals to the RF motherboard 545 via a ribbon cable. Mating pins are provided on the controller and motherboard to accept the ribbon cable connectors.

The RF modules 515 are connected to the motherboard using a flex circuit. This flex circuit is made of 0.015″ thick Kapton and has a matching footprint of the lower dielectric spacer (1.7″×1.8″) and has an additional 0.375″ extension that hangs off the 1.7″ wide edge. The side of the circuit bonded at the dielectric spacer is completely copper except for a cross-shaped aperture, centered on the spacer. The exterior side of the circuit has two microstrip lines that cross the aperture and proceed down to the extension, plus the copper extends past the Kapton to allow a ribbon-type connection to the motherboards 545. At the bottom of the spacers 560 and throughout the extension there are coplanar ground pads around these lines. These ground pads 570 are connected to the reverse side ground through vias. These ground pads also extend slightly past the Kapton. Each module extension 530 can be laid on top of the motherboard and is soldered in place, both ground and main trace. All copper traces are protected by immersion nickel-gold plating.

End User Interconnect and Interfaces

The two coaxial cables carry the RF signals between the antenna and the WLAN transceiver card. One cable is used to carry each linear polarization, horizontal and vertical, for diversity. Both cables have an MMCX plug on one end and a connector which mates to the card on the other. This mating connector may be an MMCX, SMA, or a proprietary connector, depending upon the brand of card being interfaced. The product should have cable length options such as 12″ and 24″ for a laptop connection and 36″ and 48″ for desktop connections.

The digital cable carries the command interface, and is a standard bi-directional IEEE-1284 parallel cable with male DB-25 connectors, and made in identical lengths as the RF cable. The DC power supply is a wall-mount transformer with integral cable that terminates in a DC power plug. This cable plugs into the antenna's DC powerjack.

Radome Housing

A formed black ABS radome encloses the present invention and protects the internal components. The outer diameter matches the base at 6.5″, and the height aligns to the base vertical posts, for a part height of 2.5″. Thus the antenna is 3.0″ in total height. The radome has a nominal wall thickness of 0.063″ and a 1° draft angle. The top of the radome is nominally 0.125″ thick.

Fabrication

The controller can be screwed to the bottom of the base. The internal coaxial cable bulkheads are secured to the base. The copper ribbon extensions of the RF modules are soldered in a flat orientation to the RF motherboard. The snap-on ends of the coaxial cables are attached to the motherboard/module assembly, which is lowered in place between the base vertical posts. The RF modules are secured to the posts, perpendicular to the motherboard. The radome is fused to the base at its bottom and at the upper vertical posts.

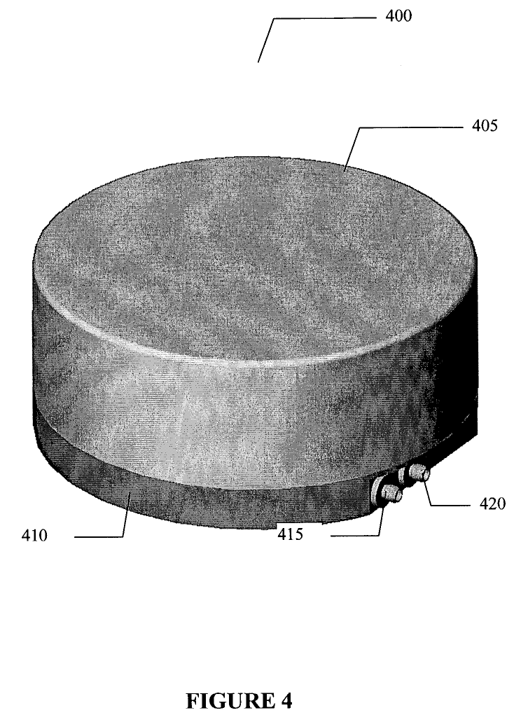

For further elaboration of the fabrication of the present invention, FIGS. 4, 5, 6, 7 and 8 depict the present in invention with various levels of expansion. FIG. 4 depicts the WLAN antenna 400 of the present invention in a completely fabricated view with the Radome 405 placed on top of base 410 with RF connectors 415 and 420 protruding from base 410.

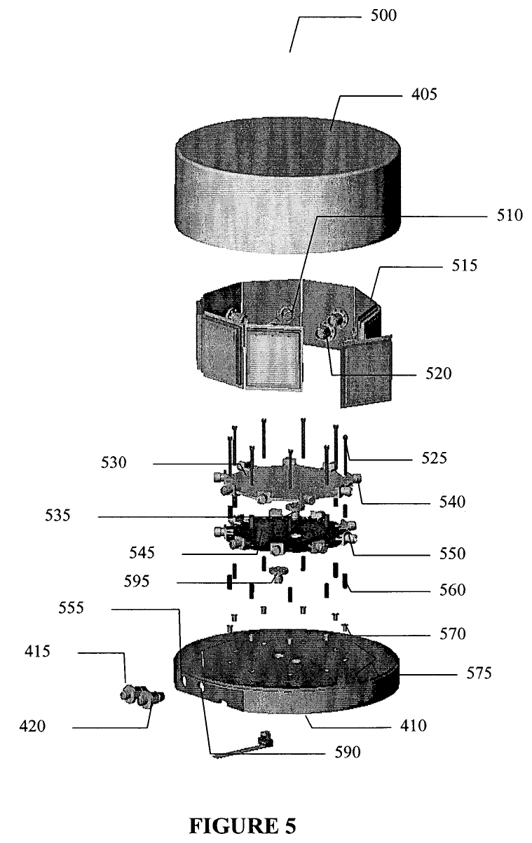

FIG. 5 is an exploded view of the WLAN antenna of the present invention wherein all of the internal components of antenna 400 can be seen. These include radome 405 and base 410 with representative RF module 515 and RF connectors 510 and 520 located within said RF module 515. Expansion module 530 also has RF connectors represented by 540. Posts for securing are depicted at 525 and spaces at 560. As described above RF motherboard is shown at 545 immediately above base 410 and attached by screws 570. Main connectors 595 and 535 are shown connected to RF motherboard 545 and expansion module 530. Also connected to RF motherboard 545 is RF connector 550.

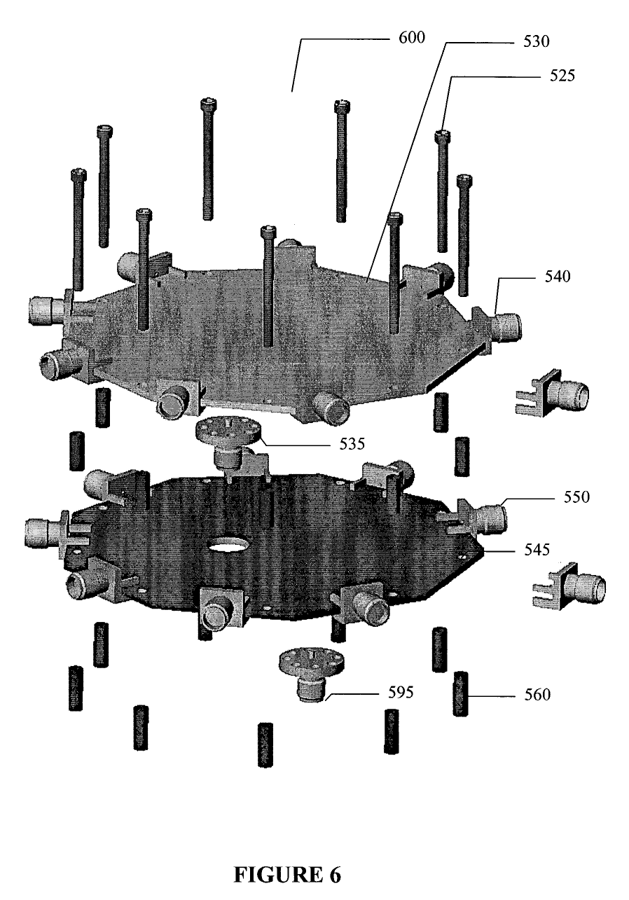

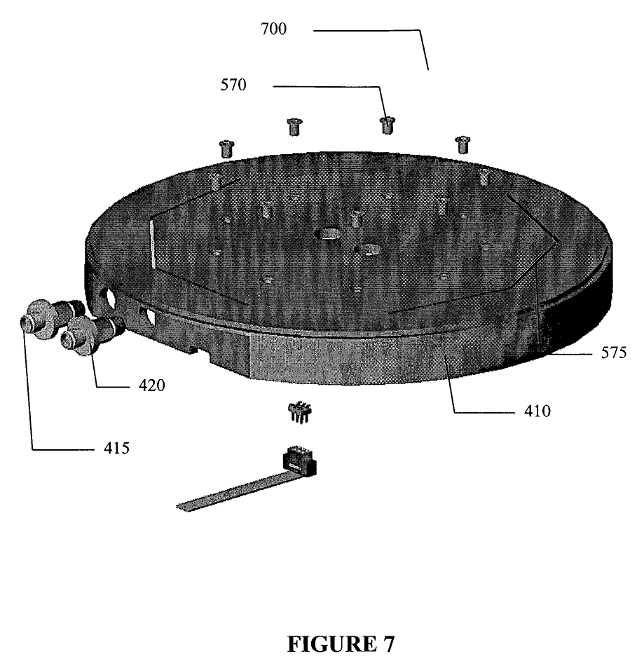

To more clearly depict the construction, FIG. 6 is a more detailed exploded view of the RF Boards construction of the WLAN antenna of the present invention showing the construction of expansion module 515 and RF motherboard 545. Further, FIG. 7 is a more detailed exploded view of the base 410 construction of the WLAN antenna of the present invention;

FIG. 8 is a more detailed exploded view of the RF Module construction of the WLAN antenna of the present invention. This includes the placement of the dielectric material 810 and 820 adjacent to metal 805, 815 and 825. Although, the present depiction shows two dielectric layers and three metal layers, different layers can be used based on design choices and performance requirements.

Lastly, FIG. 9 shows an actual representation of the invention herein described with base 410 allowing for RF connectors 420 and 415 and DC connector 905 and controller connector 915 with screws 910 and 920 for securing said controller connector.

While the present invention has been described in terms of what are at present believed to be its preferred embodiments, those skilled in the art will recognize that various modifications to the disclose embodiments can be made without departing from the scope of the invention as defined by the following claims.

What is claimed is:

1. An antenna for a wireless local area network, comprising:
at least one multi-layered RF module, said at least one RF module further comprising at least one RF connection for receipt of at least one RF signal and at least one tunable device.
an RF motherboard for acceptance of RF signals and distribution of the transmit energy to said RF module at the appropriate phases to generate a beam in the commanded direction and width; and
a controller for determining the correct voltage signal to send to said at least one multi-layered RF module.

2. The antenna for a wireless local area network of claim 1, wherein said at least one RF signal is at least two RF signals to allow for horizontal and vertical polarization.

3. The antenna for a wireless local area network of claim 1, wherein said at least one RF module is nine RF modules.

4. The antenna for a wireless local area network of claim 1, wherein said antenna interfaces with a transceiver card.

5. The antenna for a wireless local area network of claim 4, wherein said transceiver card is a PCMCIA card in a laptop computer.

6. The antenna for a wireless local area network of claim 4, wherein said transceiver card is a PCI card in a desktop computer.

7. The antenna for a wireless local area network of claim 1, wherein said beam width and steer have at least a 6 dBi gain throughout a 360 degree azimuth scan.

8. The antenna for a wireless local area network of claim 1, further comprising a Radome surrounding said at least one RF module and said RF mother board.

9. The antenna for a wireless local area network of claim 1, further comprising a base attached to said radome housing said controller, said base provides openings for reception of an RF connector, power supply and data input.

10. The antenna for a wireless local area network of claim 1, wherein said antenna operation is in the 2.4 GHz band or the 5.1 to 5.8 GHz band or both.

11. The antenna for a wireless local area network of claim 1, further comprising a software driver to control the said antenna azimuth scan angle to maximize a received wireless signal.

12. The antenna for a wireless local area network of claim 1, further comprising a three way divider, the output of said power divider connects to a phase shifter module.

13. A wireless local area network, comprising:
an access point, said access point comprising a first transceiver, said first transceiver including an antenna, said antenna comprising at least one multi-layered RF module, said at least one RF module further comprising at least one RF connection for receipt of at least one RF signal and at least one tunable device; an RF motherboard for acceptance of RF signals and distribution of the transmit energy to said RF module at the appropriate phases to generate a beam in the commanded direction and width; a controller for determining the correct voltage signal to send to said at least one multi-layered RF module; and
a second transceiver in communication with said first transceiver.

14. The wireless local area network of claim 13, wherein said access point is in communication with a wide area network.

15. The wireless local area network of claim 14, wherein said wide area network is the Internet.

16. The wireless local area network of claim 13, wherein said second transceiver is associated with an informational terminal.

17. A wireless local area network access point, comprising:
a transceiver;
an antenna associated with said transceiver, said antenna comprising:
at least one multi-layered RF module, said at least one RF module further comprising at least one RF connection for receipt of at least one RF signal and at least one tunable device;
an RF motherboard for acceptance of RF signals and distribution of the transmit energy to said RF module at the appropriate phases to generate a beam in the commanded direction and width; and
a controller for determining the correct voltage signal to send to said at least one multi-layered RF module.

18. A wireless method of data transmission from an access point in a local area network, comprising the steps of:
providing a transceiver within said access point, said transceiver further including an antenna, said antenna comprising:
at least one multi-layered RF module, said at least one RF module further comprising at least one RF connection for receipt of at least one RF signal and at least one layer of tunable dielectric material and one layer of metal;
an RF motherboard for acceptance of RF signals and distribution of the transmit energy to said RF module at the appropriate phases to generate a beam in the commanded direction and width;
a controller for determining the correct voltage signal to send to said at least one multi-layered RF module; and
transmitting information via said antennas using directional beams.

19. The method according to claim 18, wherein said access point is in communication with a wide area network.

20. The method according to claim 18, wherein said directional beam can have either horizontal or vertical polarization.

21. An RFID tag reader, comprising
a transceiver;
an antenna associated with said transceiver, said antenna comprising:
at least one multi-layered RF module, said at least one RF module further comprising at least one RF connection for receipt of at least one RF signal and at least one tunable device;
an RF motherboard for acceptance of RF signals and distribution of the transmit energy to said RF module at the appropriate phases to generate a beam in the commanded direction and width; and
a controller for determining the correct voltage signal to send to said at least one multi-layered RF module.

22. A smart card reader, comprising
a transceiver;
an antenna associated with said transceiver, said antenna comprising:
at least one multi-layered RF module, said at least one RF module further comprising at least one RF connection for receipt of at least one RF signal and at least one tunable device;
an RF motherboard for acceptance of RF signals and distribution of the transmit energy to said RF module at the appropriate phases to generate a beam in the commanded direction and width; and
a controller for determining the correct voltage signal to send to said at least one multi-layered RF module.

23. The antenna for a wireless local area network of claim 1, wherein said at least one tunable device is at least one layer of tunable dielectric material and one layer of metal.
